(19) United States
(12) Patent Application Publication
(10) Pub. No.: US 2021/0394935 A1
(43) Pub. Date: Dec. 23, 2021

(54) Omnidirectional Electrostatic Thruster

(71) Applicant: Christian KENDALL, Jenks, OK (US)

(72) Inventor: Christian KENDALL, Jenks, OK (US)

(21) Appl. No.: 17/393,520

(22) Filed: Aug. 4, 2021

Related U.S. Application Data
(63) Continuation of application No. 16/249,111, filed on Jan. 16, 2019, now abandoned.
(60) Provisional application No. 62/618,566, filed on Jan. 17, 2018.

(51) Int. Cl. B64G 1/40; F03H 1/00; B64G 1/26

(52) U.S. Cl. CPC B64G 1/405; B64G 1/26; F03H 1/0037

(57) ABSTRACT

An omnidirectional electrostatic thruster having an insulating shell; an inner shell; a charged material; a plurality of pairs of conductive plates; a control unit; and, a power source. The inner shell envelopes the charged material. The insulating shell envelopes the inner shell. The power source provides power to the plurality of pairs of conductive plates through the control unit.

### CROSS-REFERENCE TO RELATED APPLICATIONS

This application is a continuation of U.S. patent application Ser. No. 16/249,111, filed Jan. 16, 2019, which claims priority to U.S. Provisional Application No. 62/618,566, filed Jan. 17, 2018, both of which are hereby incorporated by reference in their entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to omnidirectional electrostatic thrusters. The present invention converts electrical force on a net charged object within an electrical field into a mechanical force which may act upon the component containing the net charged object. This can produce an electromotive force on a movable component or generate a net thrust on the entire device given the movable component is physically connected to a power source. Mechanical force or thrust is produced in a direction parallel to any electric field applied across the component containing the net charged object. Sufficient charge-to-mass ratio in this component and a sufficient energy density in a power source allows this novel omnidirectional electrostatic thruster to exert a force on a load adjacent or attached to the device. The force on the movable component could also be used with a portable or stationary (non-portable) power source towards more conventional uses of electrostatic motors such as moving a small load or a rotor relative to the power source (as in stage adjustment for microscopes) or in a haptic feedback unit that can apply a small amount of force on or across a user's clothing or skin when activated by a digital signal.

Almost all electrical motors and micromotors translate or rotate moving components relative to a power source and/or a fixed component. This is usually achieved by 1) moving an electromagnetic or ferromagnetic component over an active range in an induced magnetic field or electric field, or 2) repelling and/or attracting a charged component to or from an electrode with a certain charge and electric potential. Taking advantage of similar phenomena to the second type of device just described, electrostatic and ionic thrusters charge or ionize a material and propel the material out of a chamber, down an electric potential drop or gradient in an electric field.

Electrical and electrostatic motors require mining or creating bulk ferromagnetic materials, or, more commonly, inducing charge or running a current through the moving component by using power from a secondary source or the power source which generates the repelling and/or attracting field or charge which acts on the moving component. For example, a Franklin motor uses the power source that generates a charge and electric potential on the electrode(s) that repel and/or attract the charged regions of the moving component(s), specifically, an insulated rotor with conductive regions.

On the other hand, ionic thrusters use an onboard power source to charge or ionize a propellant. The propellant is ejected to create thrust, ultimately exhausting the supply of chargeable or ionizable material available, limiting operation by the energy density of the chargeable material that the thruster can transport in conjunction with any added load.

While the idea of applying electrical force to ions or charged mass is not new, electrostatic motors act on electrodes in a rotor or move a component along a track or within a tube by loading it with transient charge or current from the power source generating the electromotive force, or a secondary power source that must remain connected to the device for operation. Electrostatic and ionic thrusters also move charged material or ions down an electric potential drop or gradient in an electric field. However these also use an onboard power source to charge the material, and do not attempt to contain the charge material in a resistive shell. Therefore electrostatic and ionic thrusters exhaust the supply of charged or chargeable material available, limiting operation by the energy density of charged or chargeable material that the thruster can transport in conjunction with any added load. It is also worth noting that all of these devices operate in a rotational or linear fashion: producing torque or producing force in one- or two-directions restrained by direction these devices are designed to move the moveable components or material ad-hoc and by design.

The present invention differs from the devices described above in construction and operating principles that generate force and thrust. Charge is loaded into the moving component by transferring material, charged by an electrostatic generator, into a rigid container surrounded by insulating material. Therefore, power is used to charge the moving component during fabrication, and short circuit or connection to power is not required to load charge on the moving component during operation.

Work or movement is achieved by applying an electric field across the moving component, containing charged material. Instead of propelling the charged material outward (as in the ionic thruster) and instead of translating or rotating the moving component down a track or around a stator, a constant potential gradient is maintained across the charged material inside the moving component by allowing the electrodes, the insulator separating the electrodes from the charged material, and the charged material to all move together as the electrical force on the charged material converts to mechanical force on the rigid shell of the moving component (the resistivity of the insulating layer not allowing the charge carriers to flow from inside the moving component to the electrodes connected to the power source).

### BRIEF SUMMARY OF THE INVENTION

An object of the present invention is an omnidirectional electrostatic thruster comprising an insulating shell; an inner shell; a charged material; a plurality of pairs of conductive plates; a control unit; and, a power source. The inner shell envelopes the charged material. The insulating shell envelopes the inner shell. The power source provides power to the plurality of pairs of conductive plates through the control unit.

In another embodiment of the present invention, the power source is a stationary power source.

In yet another embodiment of the present invention, the power source is a portable power source.

In another embodiment of the present invention, the insulating shell is a selected from the group consisting of styrofoam, aerogel, insulating oil, dielectric oil, polyethylene, polyvinyl chloride, chlorinated polyvinyl chloride, silica, glass, special purpose fused silica, pyrex, and combinations thereof.

In yet another embodiment of the present invention, the inner shell is selected from the group consisting of steel, cast iron, carbon fiber, titanium, titanium alloys, copper, brass, aluminum, aluminum alloys, polyethylene, polyvinyl chloride, chlorinated polyvinyl chloride, silica, glass, special purpose fused silica, pyrex , and combinations thereof.

In another embodiment of the present invention, the charged material is selected from the group consisting of water, ionic salts, liquid salts, ionic liquids, and combinations thereof.

In yet another embodiment of the present invention, the charged material is charged by an electrostatic generator.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 illustrates an embodiment of the present invention.

FIG. 2 illustrates an electrostatic generator utilized to charge an embodiment of the present invention.

FIG. 3 illustrates an electrostatic generator.

### DETAILED DESCRIPTION OF THE INVENTION

The present invention in this proposal converts electric potential energy into kinetic energy by applying an electric field across a moving component 210 containing charged material 130 enclosed in a sufficiently rigid and electrically resistive inner shell 120. The omnidirectional electrostatic thruster 100 stores energy in the moving component 210 containing charged material 130 in a resistive inner shell 120 by operating an electrostatic generator 200, preferably in a low-voltage setting.

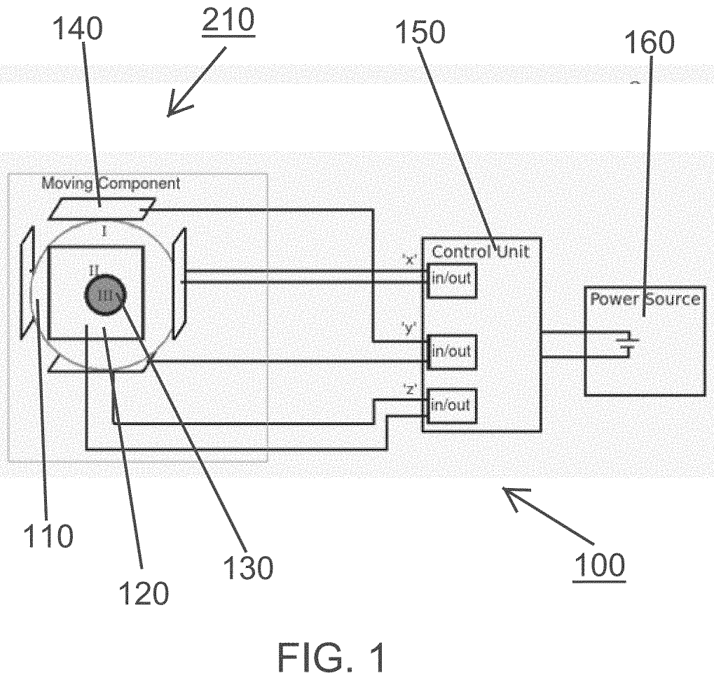

As shown in FIG. 1, an omnidirectional electrostatic thruster 100 comprises an insulating shell 110, an inner shell 120, a charged material 130, a plurality of pairs of conductive plates 140, a control unit 150, and, a power source 160. The inner shell 120 envelopes the charged material 130. The insulating shell 110 envelopes the inner shell 120. The power source 160 provides power to the plurality of pairs of conductive plates 140 through the control unit 150.

The power source 160 may be a stationary power source, such as a standard 120 V power outlet. Alternatively, the power source 160 may be a portable power source, such as a Tesla PowerWall 2 AC Battery.

The insulating shell 110 may be selected from the group consisting of styrofoam, aerogel, insulating oil, dielectric oil, polyethylene, polyvinyl chloride, chlorinated polyvinyl chloride, silica, glass, special purpose fused silica, pyrex, and combinations thereof. The insulating oil and dielectric oil may be in a rigid shell made of styrofoam, aerogel, polyethylene, polyvinyl chloride, chlorinated polyvinyl chloride, silica, glass, special purpose fused silica, pyrex, any suitable insulating material known to one skilled in the art, or combinations thereof. One of the main purposes of the insulating shell 110 is to act as an insulator that do not allow charge to freely flow.

The inner shell 120 may be selected from the group consisting of steel, cast iron, carbon fiber, titanium, titanium alloys, copper, brass, aluminum, aluminum alloys, polyethylene, polyvinyl chloride, chlorinated polyvinyl chloride, silica, glass, special purpose fused silica, pyrex, styrofoam, aerogel, any suitable rigid material known to one skilled in the art, and combinations thereof. Steel may be of various schedules and carbon/alloy compositions. Examples of special purpose fused silica include Petrocol and Nukol. One of the main purposes of the inner shell 120 is to provide rigidity to the moving component 210 of the omnidirectional electrostatic thruster 100.

In some embodiments, the insulating shell 110 and the inner shell 120 may be composed of the same materials, thereby resulting in embodiments with one shell, as opposed to embodiments with two distinct shells. The charged material 130 may be selected from the group consisting of water, ionic salts, liquid salts, ionic liquids, and combinations thereof. The charged material includes, but is not limited to, the liquid ionized and sprayed toward the target in the illustrated electrostatic generator.

Ionic salts may be dissolved in water, alcohols, or organic solvents, such as ethers and esters or any mixture of these solvents. Ionic salts include, but are not limited to, lithium chloride, lithium bromide, lithium iodide, lithium carbonate, lithium chlorate, lithium hydroxide, lithium phosphate, lithium sulfate, lithium dichromate, lithium oxide, sodium chloride, sodium bromide, sodium iodide, sodium carbonate, sodium chlorate, sodium hydroxide, sodium phosphate, sodium sulfate, sodium dichromate, sodium oxide, potassium chloride potassium bromide, potassium iodide, potassium carbonate, potassium chlorate, potassium hydroxide, potassium phosphate, potassium sulfate, potassium dichromate, potassium oxide, ammonium chloride, ammonium bromide, ammonium iodide, ammonium carbonate, ammonium chlorate, ammonium hydroxide, ammonium oxide, ammonium phosphate, ammonium sulfate, ammonium dichromate, beryllium chloride, beryllium bromide, beryllium iodide, beryllium carbonate, beryllium chlorate, beryllium hydroxide, beryllium phosphate, beryllium sulfate, beryllium dichromate, beryllium oxide, magnesium chloride, magnesium bromide, magnesium iodide, magnesium chlorate, magnesium sulfate, calcium chloride, calcium bromide, calcium iodide, calcium chlorate, calcium hydroxide, calcium sulfate, calcium oxide, strontium chloride, strontium bromide, strontium iodide, strontium chlorate, strontium hydroxide, strontium phosphate, strontium dichromate, strontium oxide,barium chloride, barium bromide, barium iodide, barium chlorate, barium hydroxide, barium oxide, barium phosphate, barium dichromate, zinc chloride, zinc bromide, zinc iodide, zinc chlorate, zinc sulfate, ferric chloride, ferric bromide, ferric iodide, ferric chlorate, ferric sulfate, ferrous chloride, ferrous bromide, ferrous carbonate, ferrous chlorate, ferrous sulfate, cupric chloride, cupric bromide, cupric iodide, cupric chlorate, cupric sulfate, cuprous chloride, cuprous bromide, cuprous iodide, cuprous chlorate, cuprous sulfate, aluminum chloride, aluminum bromide, aluminum iodide, aluminum carbonate, aluminum chlorate, aluminum sulfate, aluminum oxide, lead chloride, lead bromide, lead chlorate, lead phosphate, lead dichromate, silver chlorate, silver hydroxide, silver oxide, silver sulfate or any mixture of these salts in solution, or any commonly known ionic compounds dissolved in aqueous or organic solvents similar to those described above (e.g. lead sulfate, calcium sulfate, sodium acetate, sodium citrate, pyridinium in solutions not described as ionic liquids below).

Liquid salts include molten salts and battery electrolytes. Liquid salts include, but are not limited to, lithium fluoride, sodium fluoride, sodium nitrate, sodium nitrite, potassium fluoride, potassium nitrate, beryllium fluoride, or any combination of these in solution, such as FliNaK, FliBe, NaNO3-NaNO3-KNO3 molten salts, fluoride and chloride salts of metals, such as chromium and aluminium, commonly found in molten salts that come in contact with metal, LiPF6, LiCIO4, LiBF4, LiN(SO2CF3)2, Na3.AlF6 (Cryolite), NaS, NaAlCl4, and other sodium-ion battery electrolytes, magnesium-antimony, lead-antimony, vanadium flow battery electrolytes (e.g. VO2Cl(H2O)2), and, any mixture of these compounds with each other or with the salts in the previous section (ionic salts) to form a liquid salt or a salt in solution with very low solvent and multiple functional ions.

Ionic liquids include, but are not limited to:

[emim][EtSO4] 1-Ethyl-3-methylimidazolium ethyl sulfate,

[emim][EtSO4].hydroxylammoniurn nitrate,

[NH2p-bim][BF4] 1-propylamide-3-butyl imidazolium tetrafluoroborate,

[P(C4)4][Ala] Tetrabutylphosphoniuml-α-aminopropionic acid salt,

[P(C4)4][Gly] Tetrabutylphosphonium aminoethanoic acid salt,

[P66614][Met] trihexyl(tetradecyl)phosphonium methioninate,

[P66614][Pro] trihexyl(tetradecyl)phosphonium prolinate,

[aP4443][Gly] (3-Aminopropyl)tributylphosphonium aminoethanoic acid salt,

[aP4443][Ala] (3-Aminopropyl)tributylphosphoniuml-α-aminopropionic acid salt,

[aemmim][Tau] 1-aminoethyl-2,3-dimethylimidazolium taurine salt,

[MTBDH+][TFE−] 9-methyl-2,3,4,6,7,8-hexahydropyrimido[1,2-a]pyrimidine trifluoroethanol,

[MTBDH+][Im−] 9-methyl-2,3,4,6,7,8-hexahydropyrimido[1,2-a]pyrimidine imidazole,

[(P2-Et)H+][TFE−] Tetramethyl(tris(dimethylamino)phosphoranylidene)phosphorictriamid-Et-imin trifluoroethanol,

[MTBDH+][TFPA-−] 9-methyl-2,3,4,6,7,8-hexahydropyrimido[1,2-a]pyrimidine (1-phenyl)trifluoroethanol,

[(P2-Et) H+][lm−] Tetramethyl(tris(dimethylamino)phosphoranylidene)phosphorictriamid-Et-imin imidazole,

[MTBDH+][Pyrr−] 9-methyl-2,3,4,6,7,8-hexahydropyrimido[1,2-a]pyrimidine pyrrolidone,

[(P2-Et) H+][Pyrr—] Tetramethyl(tris(dimethylamino)phosphoranylidene)phosphorictriamid-Et-imin pyrrolidone,

[MTBDH+][PhO−] 9-methyl-2,3,4,6,7,8-hexahydropyrimido[1,2-a]pyrimidine phenol,

[(P2-Et) H+][PhO−] Tetramethyl(tris(dimethylamino)phosphoranylidene)phosphorictriamid-Et-imin phenol,

[P66614][Pyr] trihexyl(tetradecyl)phosphonium pyrazole,

[P66614][lm] trihexyl(tetradecyl)phosphonium imidazole,

[P66614][lnd] trihexyl(tetradecyl)phosphonium indole,

[P66614][Triz] trihexyl(tetradecyl)phosphonium trizole,

[P66614][Bentriz] trihexyl(tetradecyl)phosphonium bentrizole,

[P66614][Tetz] trihexyl(tetradecyl)phosphoniurn tetrazole,

[P66614][Oxa] trihexyl(tetradecyl)phosphonium oxazolidinone,

[P66614][PhO] trihexyl(tetradecyl)phosphonium phenol,

[emim][pivalate] 1-ethyl-3-methylimidazolium pivalate,

[emim][lactate] 1-ethyl-3-methylimidazolium lactate,

[emimlibenzoate] 1-ethyl-3-methylimidazolium benzoate,

[bmim][PF6] 1-butyl-3-methylimidazolium hexafluorophosphate,

[C6mim][PF6] 1-hexyl-3-methylimidazolium hexafluorophosphate,

[C8mim][PF6] 1-octyl-3-methylimidazolium hexafluorophosphate,

[C9mim][PF6] 1-nonyl-3-methylimidazolium hexafluorophosphate,

[emim][BF4] 1-ethyl-3-methylimidazolium tetrafluoroborate,

[bmim] [BF4] 1-butyl-3-methylimidazolium tetrafluoroborate,

[C6mim] [BF4] 1-hexyl-3-methylimidazolium tetrafluoroborate,

[C8mim][BF4] 1-octyl-3-methylimidazolium tetrafluoroborate,

[N-bupy][BF4] N-butylpyridinium tetrafluoroborate,

[bmim][NO3] 1-butyl-3-methylimidazolium nitrate,

[bmim][NO3].hydroxylammonium nitrate,

[HOPmim][NO3] hydroxypropylmethylimidazolium nitrate,

[emim][Tf2N] 1-ethyl-3-methylimidazolium bis(trifluoromethylsulfonyl)imide,

[bmim][Tf2N] 1-butyl-3-methylimidazolium bis(trifluoromethylsulfonyl)imide,

[dmim][Tf2N] 1,2-dimethylimidazolium bis(trifluoromethylsulfonyl)imide,

[hmim][Tf2N] 1-hexyl-3-methylimidazolium bis(trifluoromethylsulfonyl)imide,

[P14,6,6,6][Tf2N] trihexyltetradecylphosphonium bis(trifluoromethylsulfonyl)imide,

[BMP][Tf2N] 1-butyl-1-methylpyrrolidinium bis(trifluoromethylsulfonyl)imide,

[bmim][DCA] 1-butyl-3-methylimidazolium dicyanamide,

[bmim][TfO] 1-butyl-3-methylimidazolium trifluoromethanesulfonate,

[emim][EtSO4] 1-ethyl-3-methylimidazolium ethylsulfate,

[emim][C2N3] 1-ethyl-3-methylimidazolium dicyanamide,

[emim][Ac] 1-ethyl-3-methylimidazolium acetate,

[bmim][Ac] 1-butyl-3-methylimidazolium acetate,

[emim][TFA] 1-ethyl-3-methylimidazolium trifluoroacetate,

[bmim][SCN] 1-butyl-3-methylimidazolium thiocynate,

HEF 2-hydroxy ethylammonium formate,

THEAA tri-(2-hydroxy ethyl)-ammonium acetate,

HEAF 2-(2-hydroxy ethoxy)-ammonium formate,

HEAA 2-(2-hydroxy ethoxy)-ammonium acetate,

[emim][MDEGSO4] 1-ethyl-3-methylimidazolium 2-(2-methoxyethoxy)ethylsulfate,

quaternary ammonium compounds, coco alkylbis (hydroxyethyl)methyl,

ethoxylated, chlorides, methyl chloride (TEGO IL K5),

Tetra-Heptyl Ammonium in Formamide, and, combinations thereof.

FIG. 1 illustrates an embodiment of the present invention. The omnidirectional electrostatic thruster 100 includes a moving component 210 comprises an insulating shell 110, inner shell 120 and charged material 130, that are positioned between three pairs of conductive plates 140 or otherwise axis-aligned conductive components. The pairs of conductive plates 140 are aligned in three orthogonal directions, allowing establishment of an electric field, in one of six directions, across the charged material within the moving component 1 when a potential is applied across any of these pairs of conductive plates 140. The charged material 130, sealed in a resistive inner shell 120 and surrounded by the pairs of conductive plates 140, is held within an insulating shell 110 that can mount on a chassis or attach to a load. The pairs of conductive plates 140 connect to power outlets in a control unit 150 consisting of transistors and switches or other circuitry for distributing power from the power source 160 and changing the voltage applied across each outlet. A single power source 160 connects to the control unit 150. The power source 160 may be stationary or portable and may provide alternating or direct current. A stationary power source, such as an ordinary household power outlet, may generate force on the moving component 210 attached to a load in any direction relative to the power source 160. A portable power source, such as a battery, may be mounted onto a chassis along with the moving component 210, converting force on the moving component 210 into thrust that acts on the chassis and translates the entire omnidirectional electrostatic thruster 100 along with any attached load. Sub components of the moving component 210 include the insulating shell 110 (also labeled as “I”) containing charged material 130 (also labeled as “III”) and surrounded by pairs of conductive plates 140. The insulating shell 110 (also labeled as “H”) contains the charged material 130 that may be loaded with charge during fabrication of the moving component 210 of the omnidirectional electrostatic thruster 100.

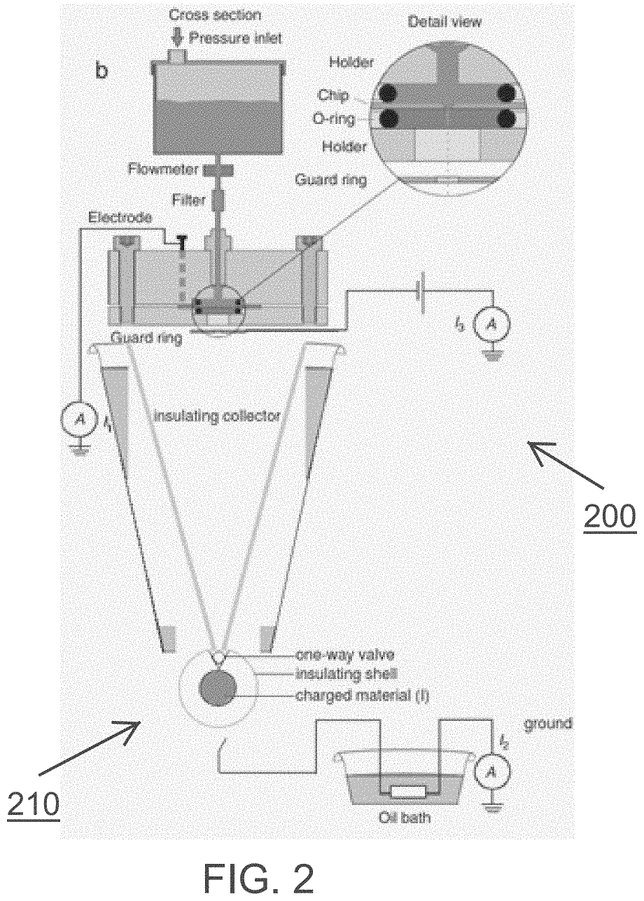

The charged material 130 is charged by an electrostatic generator 200. FIG. 2 illustrates a possible advantageous arrangement for connecting an electrostatic generator 200 to the moving component 210 of the omnidirectional electrostatic thruster 100. The charged material 130 is directly deposited into the moving component 210. An insulating collector prevents charge from being carried away from the charged material 130 as it is sprayed toward the moving components 210 inner shell 120. A one way valve facilitates accumulation of charged material 130 in the moving component 210 with force from gravity and/or applied pressure. The insulating shell 110 of the moving component 210 is sealed in a following step for operation and to prevent accidental short circuits via the valve.

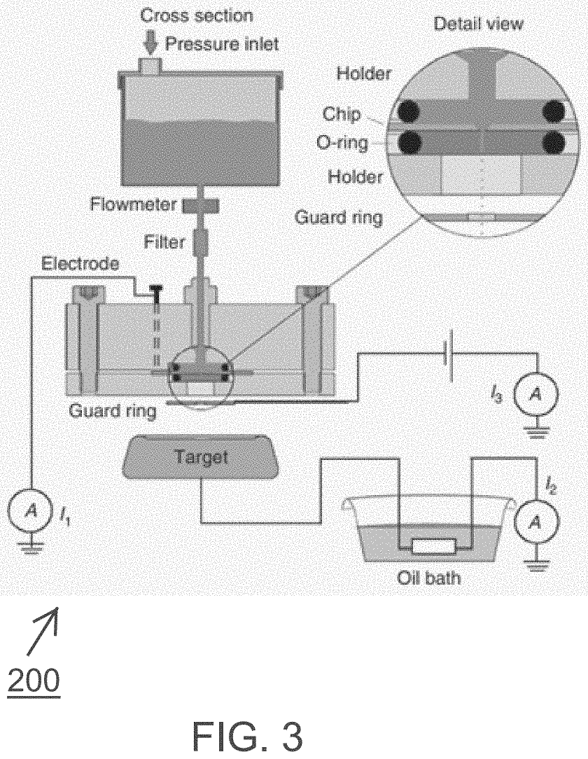

FIG. 3 is a schematic of electrostatic generator which transfers charge onto a target. While many electrostatic generators may be used to induce charge on desired components, this arrangement converts kinetic energy into electrostatic energy by charging liquid using the flowing current phenomenon and enhancing it with inductive charging. As charged material accumulates on a conductive target, mechanical energy in the form of pressure converts to electrostatic energy by working against a building electric potential on the target.

As an example, the assembly of the charged material 130 may consist primarily of the following steps:

(1) Charging the material with the electrostatic generator in FIG. 2 or a similarly constructed generator using electrospray ionization directed at a charge-collecting target;

(2) Trapping the charged material 130 in a container by directing the collected material or the ion droplet spray itself into a removable and sealable inner shell 110. The membrane, holder, and guard ring of the electrostatic generator are connected to a collector that terminates in a connection to a one-way valve in the exterior of a rigid inner shell 120 that, in turn, comprises the interior of the charge-containing component once detached. With an insulated chamber that has a one-way interface with the interior of the moving component's 210 rigid inner shell 120, the ion spray may be collected into volumes of varying shape. Also, additional pressure may be applied to force charged material into the inner shell 120; and,

(3) Attaching electrodes (pairs of conductive plates 140) on opposite sides of the moving component 210 in three orthogonal dimensions (i.e. left-and-right, top-and-bottom, front-and-back sides) and connecting the pairs of conductive plates 140 to a single on-line or on-board power source 160 with circuitry to control power flow across each pair of conductive plates 140. The resulting omnidirectional electrostatic thruster 100 allows arbitrary combinations of force vectors acting on the charge-containing component to be generated by controlling the direction of power from the power source 160 to apply potentials across each of the pairs of conductive plates 140 respectively. The possible resulting combinations of force vectors on the charge-containing moving component 210 allow for generation of mechanical force in any desired direction in three-dimensional space.

Another example of assembling of the charged material 130 if by filling the inner shell 120 with the charged material 130 to be used by the moving component 210. The charged material 130 is then charged by induction. The inner shell 120 is then sealed in the insulating shell 120.

Further, the velocity and range of movement for the moving component 210 are only limited by the single power source 160 and the achievable charge-to-mass ratio of the charged material within the moving component 210 at the fabrication steps described earlier. Physically attaching the moving component 210 to a power source 160 of sufficient energy density results in an omnidirectional electrostatic thruster 100 that can achieve translational motion in all directions. Operating at lower power, with a fixed power source 160 (or with a low energy density power source 160 and/or a low charge-to-mass ratio moving component 210) still allows for applications of the omnidirectional electrostatic thruster 100 to translate the moving component 210 relative to the power source 160 with unprecedented degrees of freedom in space. This allows exertion of force on an external load in any direction accessible to digital control interfaces, wherein the moving component 210 can push or pull on a strap affixed to a user's finger in a haptic feedback device.

The figures are illustrative and not limiting. For example, FIG. 1 illustrates an embodiment of the present invention with three pairs of conductive plates 140. The present invention may also be practiced with two pairs or more than three pairs of conductive plates 140. Furthermore, the pairs of conductive plates 140 are exemplarily illustrated as flat, planar, and square. However, the pairs of conductive plates 140 may be round, triangular, concave, convex, or any other suitable shape. The conductive plates 140 may be in any suitable arrangement such that an electric field may be applied across the charged material 130 in multiple directions. Additionally, the pairs of conductive plates 140 does not have to be perfectly parallel, although FIG. 1 illustrates the pairs of conductive plates 140 as parallel. The first plate is oriented near a first face of the insulating shell 110, while the second plate of the pair is oriented near a second face of the insulating shell 110, whereby the first plate may be in a parallel orientation, a perpendicular orientation, or any orientation between the parallel and perpendicular orientations, with respect to the second plate.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

I claim:

1. An omnidirectional electrostatic thruster comprising:
an insulating shell;
an inner shell;
a charged material;
a plurality of pairs of conductive plates;
a control unit; and,
a power source;
wherein the inner shell envelopes the charged material;
wherein the charged material is sealed within the inner shell;
wherein the inner shell is a resistive shell;
wherein the insulating shell envelopes the inner shell;
wherein the power source provides power to the plurality of pairs of conductive plates through the control unit;
wherein each conductive plate of each pair of the plurality of pairs of conductive plates is attached on opposite sides of the insulating shell; and,
wherein when the power source is applied to the plurality of pairs of conductive plates, a potential across the plurality of pairs of conductive plates creates a thrust force.

2. The omnidirectional electrostatic thruster of claim 1, wherein the power source is a stationary power source.

3. The omnidirectional electrostatic thruster of claim 1, wherein the power source is a portable power source.

4. The omnidirectional electrostatic thruster of claim 1, wherein the insulating shell is selected from the group consisting of styrofoam, aerogel, insulating oil, dielectric oil, polyethylene, polyvinyl chloride, chlorinated polyvinyl chloride, silica, glass, special purpose fused silica, pyrex, and combinations thereof.

5. The omnidirectional electrostatic thruster of claim 1, wherein the inner shell is selected from the group consisting of steel, cast iron, carbon fiber, titanium, titanium alloys, copper, brass, aluminum, aluminum alloys, polyethylene, polyvinyl chloride, chlorinated polyvinyl chloride, silica, glass, special purpose fused silica, pyrex, and combinations thereof.

6. The omnidirectional electrostatic thruster of claim 1, wherein the charged material is selected from the group consisting of water, ionic salts, liquid salts, ionic liquids, and combinations thereof.

7. The omnidirectional electrostatic thruster of claim 1, wherein the charged material is charged by an electrostatic generator.

8. The omnidirectional electrostatic thruster of claim 1, wherein the omnidirectional electrostatic thruster comprises three pairs of conductive plates.
